(19) United States
(12) Patent Application Publication
(10) Pub. No.: US 2005/0173934 A1
(43) Pub. Date: Aug. 11, 2005

(54) Device for maintaining the threshold bar on the floor

(76) Inventors: David Neuman, Paris (FR); Michel Neuman, Paris (FR); Julien Cristiani, Mimet (FR)

Correspondence Address: YOUNG & THOMPSON, 745 SOUTH 23RD STREET, 2ND FLOOR, ARLINGTON, VA, 22202, US

(21) Appl. No.: 11/008,136

(22) Filed: Dec. 10, 2004

Related U.S. Application Data
(63) Continuation-in-part of application No. PCT/FR03/01669, filed on Jun. 4, 2003.

(30) Foreign Application Priority Data
Jun. 10, 2002 (FR) 02/07068

(51) Int. Cl. E05C 17/36

(52) U.S. Cl. 292/264

(57) ABSTRACT

The invention concerns a device for maintaining on the ground the threshold bar, the bar which is used to assemble at a door two facings on the floor and which tends to be lifted at said ends. The device comprises a female part (1) provided with toothed notches (2) and a male part (3) provided with toothed notches (4) having a shape matching that of the toothed notches of the female part so as to fix the device on the door jamb (5). The male part and the female part are provided with an antiskid portion (6). The plate (7) of the male part is such that fixing the device on the door jamb prevents the threshold bar (8) from being lifted. The inventive device is designed to maintain on the ground threshold bars present in most dwellings.

### FIELD OF THE INVENTION

The present invention concerns a device, which can fasten to the jamb of a door.

The present invention concerns a device for maintaining on the floor the carpet bar, i.e. the bar which serves to make a transition at a door between two facings on the floor.

The device is also intended for maintaining cables passing along a door opening on a top corner of a door jamb.

### BACKGROUND OF THE INVENTION

Carpet bars are usually constituted of one or two self-adhesive or screwed elements. However, these bars tend to be lifted up at their ends, and this may hinder the closing of the door or even damage it and cause home accidents.

An object of the invention is to provide a device, which allows remedying this drawback.

It is often necessary to pass cables through a door opening, for instance in the film industry. It is necessary to secure the cables so that they do not hinder the passage of people walking through the door.

Another object of the invention is to provide a device, which allows securing cables passing through a door.

### SUMMARY OF THE INVENTION

The device according to the invention allows remedying this drawback. It comprises a fastening system, which can fasten to the jamb of the door.

This device comprises a base with a plate arranged thereon. The plate is transverse to the carpet bar and maintains it pressed against the floor. In a first use of the invention, the device is secured at a bottom corner of the door jamb.

The plate may hold cables in a top corner of the door jamb. In this other use of the invention, the device is secured at a top corner of the door jamb.

In one aspect, the invention provides a device for maintaining a carpet bar on a floor or maintaining cables passing along a door opening, characterized in that it comprises a plate adapted to maintain an end of the carpet bar on the floor and a fastening system for fastening said device to a door jamb, said fastening system comprising two parts connected by toothed notches and being adaptable to the width of said door jamb, said fastening system being entirely situated on one side of said plate.

The same device is suitable for holding cables in the corner of a door jamb.

According to particular embodiments:
The fastening system may be adaptable to the width of the jamb thanks to toothed notches, which connect the two parts together.
The female part of the fastening system may be open at its base to allow the male part to slide along the length of the toothed notches.
An antiskid material provided at the device-jamb contacts may provide a better fastening.
The female part may be in the shape of an F, a vertical branch of said F being intended to be partially in contact with the door jamb, a lower horizontal branch of said F being provided with toothed notches, said male part being in the shape of a square bracket, a first branch of the square bracket being intended to be in contact with the jamb, a second branch of the square bracket being provided with toothed notches having a shape matching that of the toothed notches of the female part so as to adapt the distance between said second branch and said vertical branch to the width of the jamb, for fastening said device to said jamb by non-sliding contact.
The device may comprise portions intended to be in contact with said door jamb, said portions being provided with an antiskid surface.
The shape of the two parts may be developable.
The fastening system may comprise a male part and a female part, said female part comprising a first branch and a second branch, said second branch comprising leafs defining a space for receiving said male part.
The male part may be in the shape of a square bracket and comprise a tightening conformation.

### BRIEF DESCRIPTION OF THE DRAWINGS

The invention will be better understood by virtue of the description which will follow, given by way of nonlimiting examples with reference to the drawings.

The accompanying drawings show the invention:

FIG. 1 shows, in perspective view, a device according to a first embodiment of the invention.

FIG. 2 shows, in sectional view, the two parts of the device of FIG. 1.

FIG. 3 shows, in perspective view, the female part of a device according a second embodiment of the invention.

FIG. 4 is a top view of the part of FIG. 3.

FIG. 5 is a front view of the part of FIG. 3.

FIG. 6 is a side view of the part of FIG. 3.

FIG. 7 is a sectional view along line VII-VII of the part of FIG. 3.

FIG. 8 shows a detail of FIG. 7.

FIG. 9 shows, in perspective view, the male part of a device according to the second embodiment of the invention.

FIG. 10 is a sectional view of the part of FIG. 10.

FIG. 11 shows a detail of FIG. 10.

FIG. 12 is a front view of the part of FIG. 9.

FIG. 13 is a perspective view of the device according to the second embodiment of the invention.

FIG. 14 is the developed shape of the part of FIG. 3.

FIG. 15 is a top view of a carpet bar maintained on the floor by two devices according to the invention.

### DETAILED DESCRIPTION OF THE INVENTION

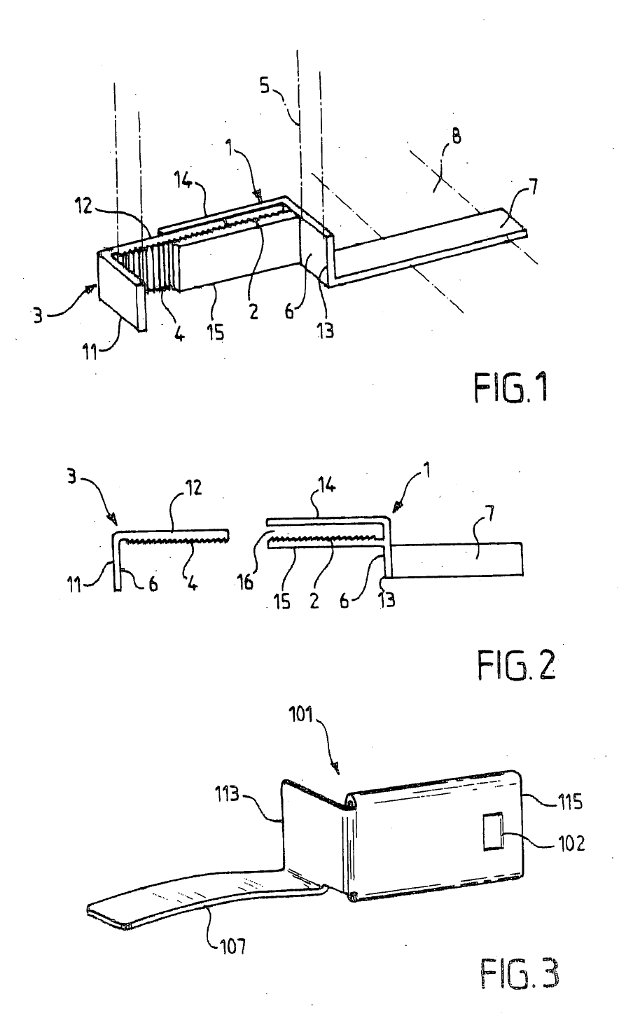

FIGS. 1 and 2 represent a device according to a first embodiment of the invention.

With references to the drawings, the device comprises a female part 1 provided with toothed notches 2 and a male part 3 provided with toothed notches 4, having a shape matching that of the toothed notches of the female part so as to fasten the device to the door jamb 5. The male part and the female part are provided with an antiskid portion 6.

The female part 1 and the male part 3 constitute a fastining system to fasten the device to the door jamb 5.

The male part 3 is in the shape of a square bracket and comprises a first branch 11 and a second branch 12 perpendicular to the branch 11. The toothed notches 4 are provided on the branch 12.

The female part 1 is in the shape of an F which comprises a vertical branch 13, a lower horizontal branch 15 perpendicular to the branch 13, and an upper horizontal branch 14 parallel to branch 15. The branches 14, 15 determine a space 16 for receiving the side 12 of the male part 3. The branch 15 is provided with toothed notches 2.

The female part 1 comprises a transverse plate 7 attached to the branch 13. Plate 7 is perpendicular to branches 11, 12, 13, 14 and 15. Branches 11, 12, 13, 14 and 15 are all entirely situated on the same side of the plate 7.

The branches 11 and 13 are provided with antiskid material, for instance rubber.

By virtue of the toothed notches 2, 4, the male part 3 is retained in the space 16. The space 16 of the female part 1 is open at its base so that the male part 3 may be removed from space 16 by sliding along the length of the toothed notches 2, 4. The length is arranged parallel to the contact plate 11, 13. The male part 3 may then be re-introduced in space 16 in another position, so as to adapt the distance between the contact plate 11, 13 to the width of the door jamb 5. The device is then fastened to the door jamb 5 by non-sliding contact between contact plates 11, 13 and door jamb 5.

When the device is secured in the bottom corner of the door jamb, the plate 7 is positioned horizontally on to top of an end of the carpet bar 8 and prevents it from being lifted.

The plate 7 of the female part is such that securing the device on the doorjamb prevents the carpet bar 8 from being lifted.

The device according to the invention is designed to maintain on the floor the carpet bar present in most dwellings.

When the device is fastened to a top corner of a door jamb, the plate 7 may be used to hold cables in the top corner of the door jamb.

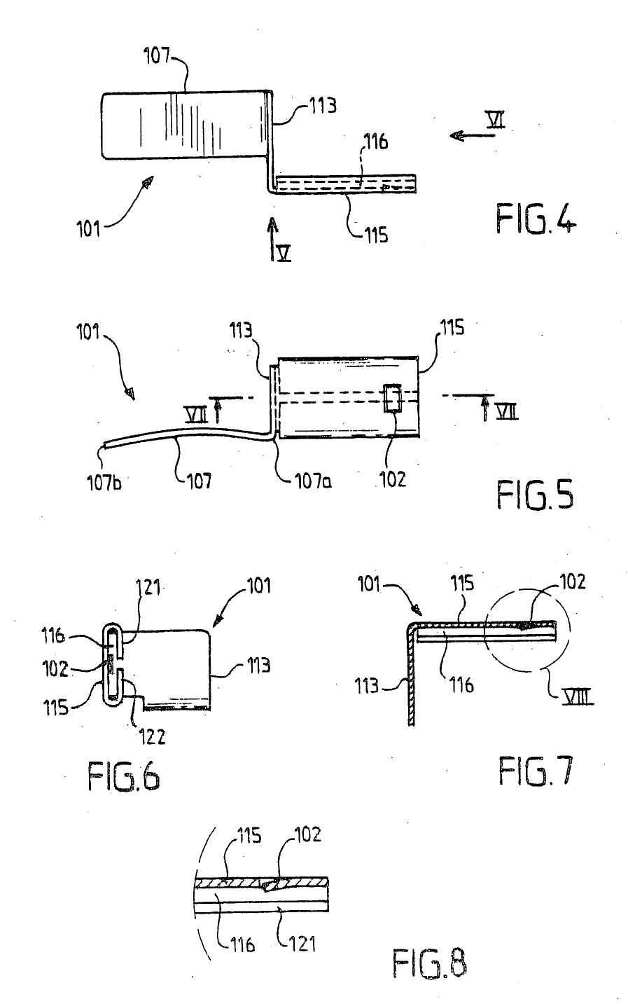

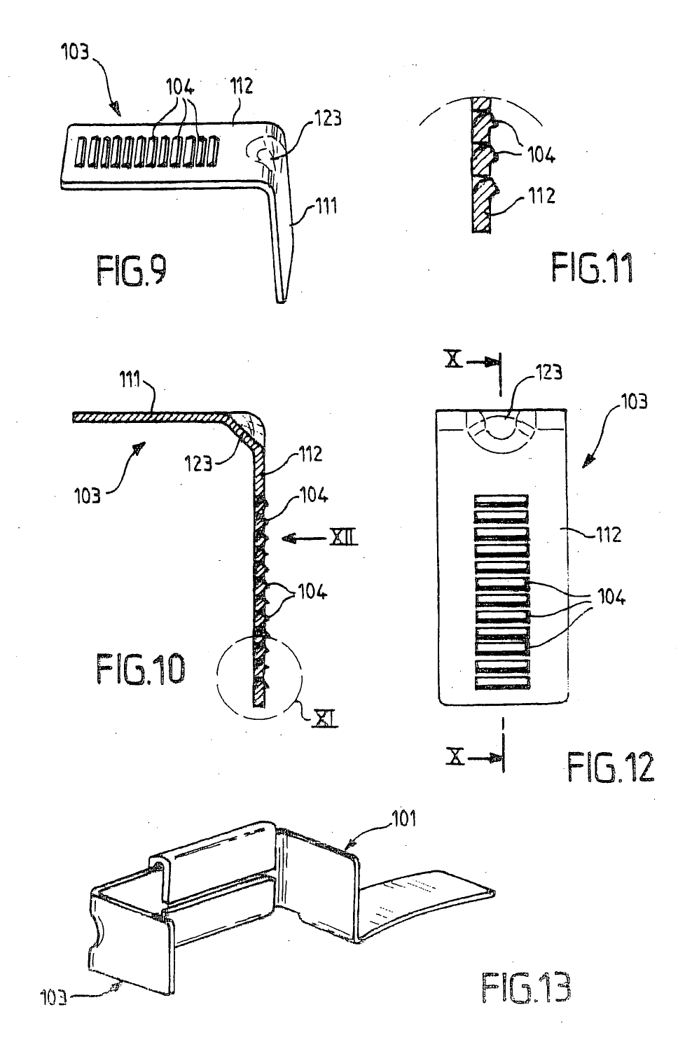

FIGS. 3 to 14 show another embodiment of the invention. FIGS. 3 to 8 show the female part 101 of this embodiment. FIGS. 9 to 12 show the male part 103 of this embodiment. FIG. 13 shows the device with female part 101 and male part 103 assembled together.

The male part 103 is in the shape of a square bracket and comprises a first branch 111 and a second branch 112 perpendicular to the branch 111. A plurality of toothed notches 104 are provided on the branch 112. The male part 103 comprises, at the junction between branches 111 and 112, a tightening conformation 123. Thanks to conformation 123, the male part 103 can hold an increased force between branches 111, 112 without being deformed.

The female part 101 comprises a first branch 113 and a second branch 115 perpendicular to the branch 113. The branch 115 comprises leafs 121, 122, which are parallel with the rest of branch 115. The leafs 121, 122 determine, with the rest of branch 115, a space 116 for receiving the branch 112 of the male part 103. The branch 115 is provided with one toothed notch 102.

The female plate 101 comprises a transverse plate 107 comprising end edges 107a, 107b. The plate 107 is attached to the branch 113 at its edge 107a. Plate 107 is slightly curved and the end edges 107a, 107b define a plane that is perpendicular to branches 111, 112, 113 and 115. Branches 111, 112, 113 and 115 are all entirely situated on the same side of the plate 107.

By virtue of the toothed notches 102, 104, the male part 103 is retained in the space 116. The width of space 116 is such that the male part 103 may be removed from space 116 by pulling branch 111 away from branch 113 with an oscillating movement, each oscillation allowing toothed notch 102 to disengage from a toothed notch 104 and to engage with the next toothed notch 104. The male part 103 may be introduced or pushed further into space 116 in a position such that the distance between the branch 111 and the branch 113 is adapted to the width of the door jamb. The device is then fastened to the door jamb by clamping branch 111 and branch 113 on the jamb.

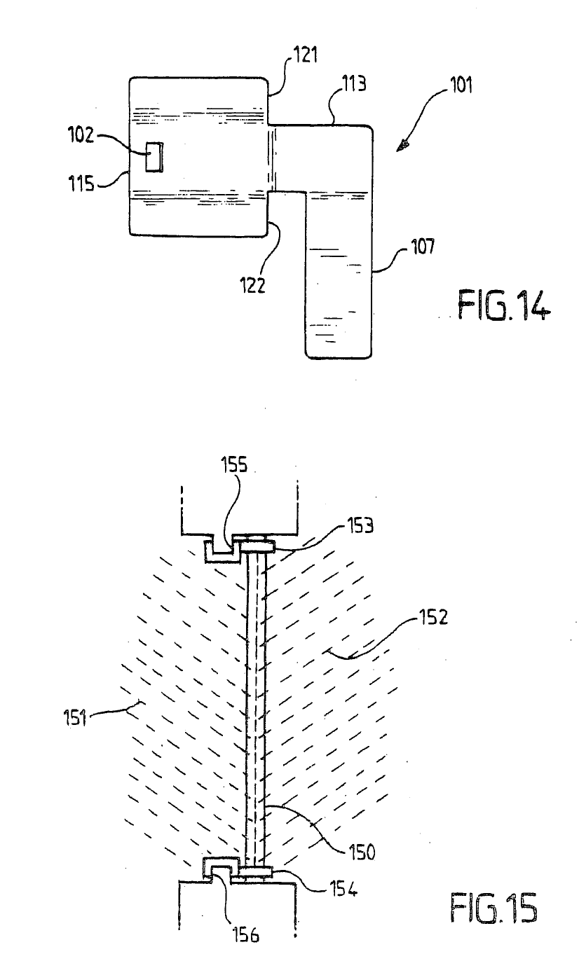

The device of the second embodiment can be made very easily and at low cost according to the following method. Constitutive parts are cut in a sheet of metal, the shapes of which corresponding to the developed shapes of the female part 101, which is represented FIG. 14, and the male part 103, which is rectangular. The notches 102, 104 are formed by stamping the developed parts. Then these developed parts are folded to form female part 101 and male part 103. The tightening conformation is formed by drawing.

In comparison, in the first embodiment it is not possible to cut a piece of sheet metal corresponding to the developed shape of female part 1, due to branches 14 and 15.

It will be appreciated that the devices described hereinbefore are suitable for maintaining a carpet bar on the floor or holding cables on one side of a door jamb. A symmetrical device may be provided for the same purpose on the other side of the door jamb. For instance, FIG. 15 shows a carpet bar 150, which serves to make a transition between the carpets 151 and 152, at a door. The carpet bar 150 extends on the floor from one side 155 of a door jamb to the other side 156. Two devices according to the invention 153, 154 are fastened to the door jamb at sides 155, 156 respectively.

1. A device for maintaining a carpet bar on a floor, characterized in that it comprises a plate adapted to maintain an end of the carpet bar on the floor and a fastening system for fastening said device to a door jamb, said fastening system comprising two parts connected by toothed notches and being adaptable to the width of said door jamb, said fastening system being entirely situated on one side of said plate.

2. The device according to claim 1, wherein said fastening system comprises a male part and a female part, said female part being open at its base to allow said male part to slide along the length of said toothed notches.

3. The device according to claim 2, wherein said female part is in the shape of an F, a vertical branch of said F being intended to be partially in contact with said jamb, a lower horizontal branch of said F being provided with toothed notches, said male part being in the shape of a square bracket, a first branch of the square bracket being intended to be in contact with said door jamb, a second branch of the square bracket being provided with toothed notches having a shape matching that of the toothed notches of the female part so as to adapt the distance between said second branch and said vertical branch to the width of the jamb, for fastening said device to said jamb by non-sliding contact.

4. The device according to claim 1, wherein said device comprises portions intended to be in contact with said door jamb, said portions being provided with an antiskid surface.

5. The device according to claim 1, wherein the shape of said two parts is developable.

6. The device according to claim 5, wherein the fastening system comprises a male part and a female part, said female part comprising a first branch and a second branch, said second branch comprising leafs defining a space for receiving said male part.

7. The device according to claim 6, wherein said male part is in the shape of a square bracket and comprises a tightening conformation.

8. The device according to claim 2, wherein said device comprises portions intended to be in contact with said door jamb, said portions being provided with an antiskid surface.

9. The device according to claim 3, wherein said device comprises portions intended to be in contact with said door jamb, said portions being provided with an antiskid surface.
